(19) United States
(12) Patent Application Publication
(10) Pub. No.: US 2016/0363284 A1
(43) Pub. Date: Dec. 15, 2016

(54) OUTER LENS FOR LIGHTING DEVICE AND PROCESS FOR THE MANUFACTURE THEREOF

(71) Applicant: Valeo Vision, Bobigny Cedex (FR)

(72) Inventors: Jean-Marc Colombel, Les Rairies (FR); Guillaume Altermatt, Angers (FR); Romain Menoret, Angers (FR)

(21) Appl. No.: 15/178,891

(22) Filed: Jun. 10, 2016

(30) Foreign Application Priority Data
Jun. 12, 2015 (FR) 1555374

(51) Int. Cl. F21S 8/10; F21V 17/10; F21V 3/04; B60Q 1/34; B29C 45/00; B29C 45/16; B60Q 1/26; B60Q 1/30; F21V 15/01; B29D 11/00

(52) U.S. Cl. CPC F21S 48/31; F21V 15/01; F21V 17/10; F21V 3/0445; F21S 48/20; B29D 11/00009; B29C 45/0025; B29C 45/16; B60Q 1/26; B60Q 1/30; B60Q 1/34; B29C 2045/0043; B29C 2045/1682; B29K 2101/12

(57) ABSTRACT

An outer lens intended to seal an opening of a housing of the lighting and/or signaling device of a motor vehicle. The outer lens comprises a first layer and a mounting prong from the first layer, the mounting prong being intended to cooperate with a peripheral rib delimiting the opening, and it comprises a second layer covering the first layer at least level with the mounting prong. A first thickness E1 of the first layer is measured level with the mounting prong and a second thickness E2 of the first layer is measured next to the mounting prong. The first thickness E1 is greater than or equal to the second thickness E2.

### CROSS-REFERENCE TO RELATED APPLICATIONS

This application claims priority to the French application 1555374 filed Jun. 12, 2015, which application is incorporated herein by reference and made a part hereof.

### BACKGROUND OF THE INVENTION

### 1. Field of the Invention

One subject of the present invention is an outer lens of a lighting and/or signaling device for a motor vehicle, the outer lens being intended to seal an opening of a housing of the lighting and/or signaling device by means of a mounting prong lodged in a rib of the housing.

### 2. Description of the Related Art

The invention also defines a lighting and/or signaling device and also a process for manufacturing a lighting and/or signaling device outer lens.

Conventionally, lighting and/or signaling device outer lenses are produced by an injection molding method, in particular by bi-injection molding when it is desired to obtain a bicolor outer lens. An outer lens of a lighting and/or signaling device has an outer face intended to be visible once the outer lens is installed on the housing of the lighting and/or signaling device and an inner face having reliefs such as a mounting prong intended to be lodged in a rib of the housing. In the outer lenses from the prior art, a plane of extension of the mounting prong extends perpendicular to the plane of the outer face of the outer lens.

The outer face must be flat, motor vehicle manufacturers not tolerating any asperities at the surface of the outer face of the lighting device. However, the injection-molded outer lenses comprising mounting prongs are exposed to a risk of defects.

Firstly, there is a considerable risk of sink marks which are defects that are observed in the solid portions of cast parts when the solidification and the shrinkage of the material lead to the formation of a cavity. Thus, the problem of sink marks is encountered in a zone level with a mounting prong made as one piece. The risk of sink marks is even more accentuated with the inclination of the plane of the prong relative to the plane of the outer lens.

### SUMMARY OF THE INVENTION

The objective of the invention is to overcome the aforementioned drawback, in particular by proposing an outer lens produced by the superimposition of at least two layers and from which a mounting prong protrudes. The invention makes it possible very particularly to produce a mounting prong that is inclined relative to the plane of the outer lens.

A first subject of the invention is an outer lens for a lighting and/or signaling device. The outer lens is intended to seal an opening of a housing of the lighting and/or signaling device, it comprises a first layer and a mounting prong protruding from the first layer. The mounting prong is intended to cooperate with a peripheral rib delimiting the opening. A second layer covers the first layer at least level with the mounting prong. A first thickness of the first layer measured level with the mounting prong is greater than or equal to a second thickness of the first layer measured next to the mounting prong.

One of the advantageous features of the invention for solving the sink mark problem is the injection molding of an overthickness of the first layer level with the mounting prong. This overthickness of the first layer makes it possible to avoid the addition, during the injection molding of the second layer, of a large additional amount level with the sink mark of the first layer and which would have the consequence of transferring the sink mark problem to the second layer, level with the mounting prong. This sink mark would therefore be visible on the outer face of the outer lens.

Thus, the overthickness level with the mounting prong covered by the overmolding overcomes the defects inherent to the molding and makes it possible to obtain a flat and perfectly smooth outer face level with the mounting prong.

Other optional features of the outer lens according to the invention, which may be implemented in a combined or alternative manner, are indicated below.

It will be noted that a first zone of the first layer bears the mounting prong and this zone is delimited by two straight lines. The measurement of the first thickness is carried out in the first delimited zone whereas the measurement of the second thickness is carried out outside of the first zone. It is in so doing that the overthickness may be observed on a lighting and/or signaling device outer lens.

Furthermore, the mounting prong is inclined relative to the plane of the first layer. This mounting prong therefore extends in a longitudinal direction and the first layer extends in another direction. The longitudinal direction and the direction of the first layer form a non-perpendicular angle, in particular of between 1° and 89° or an angle of between 91° and 179°. Advantageously, this angle is between 10° and 80° or between 100° and 170°.

The first thickness of the first layer of the outer lens is within a range of values of 1.15 to 1.25 times greater than the second thickness of the first layer. It will be noted that the variation in thickness between the first thickness and the second thickness may be progressive, in particular in a linear manner.

According to an aspect of the invention, the second layer completely covers the first layer, in particular by completely adhering to one face of the first layer, opposite the mounting prong.

The first layer and/or the second layer of the outer lens may be made from a material selected from polymethyl methacrylate, acrylonitrile butadiene styrene and polycarbonate.

Optionally, the second layer of the outer lens is translucent, that is to say having properties capable of transmitting light diffusely.

According to one example of the invention, an outer lens portion of the same material as that of the first layer and separate therefrom, is joined edge to edge with the second layer forming the outer lens. The outer lens portion may optionally be translucent. Such arrangements make it possible to form, during a same injection molding step, both the first layer and also the separate portion of the outer lens used for a signaling function. For example, the first layer and the portion may be made from a yellow material used for the direction indicator.

In one particular embodiment, the outer lens portion is distinguished from the first layer equipped with its mounting prong by a free space. In this embodiment, the second layer extends between the outer lens portion and the first layer so that the outer lens portion and the first layer are not in direct contact with one another.

According to nonlimiting examples of the invention, the outer lens portion may correspond to a direction indicator or to a reversing light. The outer lens with the exception of the portion may correspond to a stop light or to a side marker light, also known as a town light. The various materials used for the first and second layer may differ, for example and nonlimitingly, by their respective colors that may correspond to different lighting or signaling functions.

The invention also defines a lighting and/or signaling device that comprises a light source and a housing having an opening through which a light beam generated by the light source leaves the lighting and/or signaling device, the opening being sealed by an outer lens mentioned above. An embodiment is possible according to which the mounting prong is welded into the peripheral rib of the housing.

According to one example of the invention, the lighting and/or signaling device is a motor vehicle rear light.

The invention also relates to a process for manufacturing an outer lens intended to seal an opening of a housing of a lighting and/or signaling device, which comprises:

a first layer injection molded so as to create an overthickness level with a mounting prong intended to be lodged in a peripheral rib delimiting the opening; and

an injection-molded second layer covering the first layer at least level with the mounting prong.

The process has the advantageous characterization of flattening the overthickness of the first layer when the second layer is injection molded.

These and other objects and advantages of the invention will be apparent from the following description, the accompanying drawings and the appended claims.

### BRIEF DESCRIPTION OF THE ACCOMPANYING DRAWINGS

Other features, details and advantages of the invention will become more clearly apparent on reading the description given below by way of indication in connection with drawings in which:

FIG. 1 is an outer view of the outer lens of a lighting and/or signaling device according to the invention;

FIG. 2 is an exploded view of the lighting and/or signaling device, where the housing and also the outer lens are visible;

FIG. 3 is a cross-sectional view of the outer lens comprising the mounting prong cooperating with the housing of the lighting and/or signaling device; and

FIGS. 4 and 5 are cross-sectional views illustrating very particularly the overthickness made on the first layer.

### DETAILED DESCRIPTION OF THE PREFERRED EMBODIMENTS

In the features mentioned above and in the description below, the terms relating to the longitudinal direction, the horizontality, the transversality and also the terms “outer face” and “inner face” are understood relative to the position in which the outer lens of the lighting and/or signaling device is intended to be mounted.

The term “mounting prong” denotes a projection or protuberance of the injection-molded first layer that enables, during the mounting, the positioning of the outer lens owing to the cooperation of the mounting prong with a rib of the housing of the lighting and/or signaling device. And finally “two-layer outer lens” denotes an outer lens that is formed of two directly superimposed layers.

It should firstly be noted that the figures display the invention in a detailed manner in order to implement the invention, it being possible of course for the figures to be used to better define the invention where appropriate.

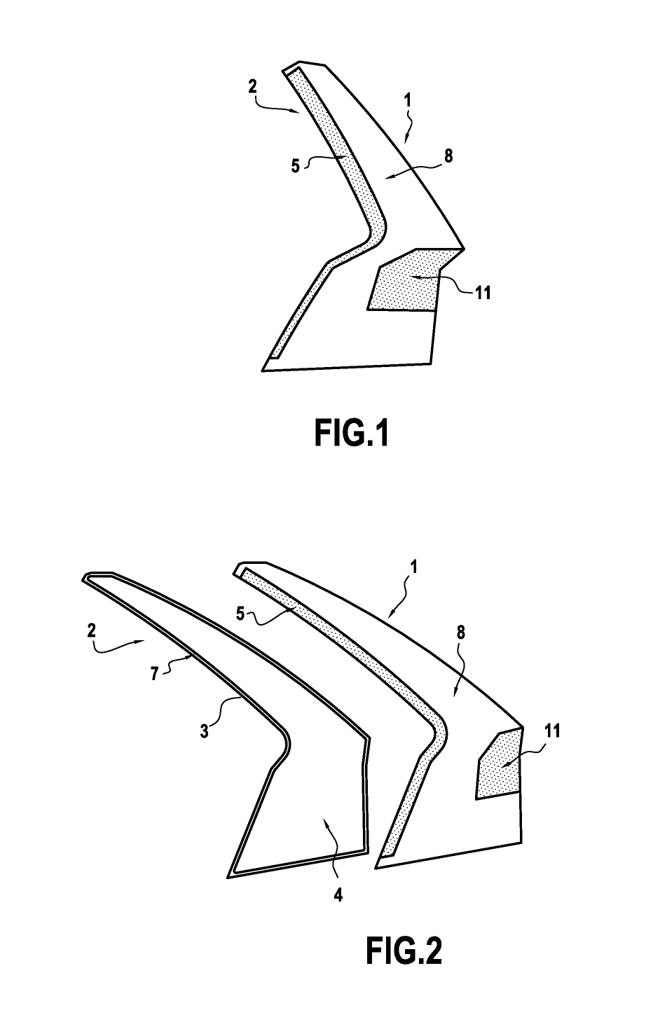

With reference firstly to FIG. 1, a representation of the outer lens 1 of the lighting and/or signaling device 2 is seen. The outer lens 1 is intended to seal an opening of a constituent housing 3 of the lighting and/or signaling device 2. The outer lens 1 is formed by the combination of a first layer 5 and of a second layer 8. This figure also illustrates one possible embodiment according to which the two-layer outer lens 1 comprises a portion 11 of outer lens 1 of the same material as that of the first layer 5. This portion 11 is, for example, joined edge to edge with the second layer 8 of the outer lens 1.

Thus, an outer face of the outer lens 1 is recognizable in that it comprises the outer lens portion 11 formed by the same material as the first layer 5, whereas the remainder of the outer lens 1 is formed by the second layer 8. The outer lens portion 11 and the remainder of the outer lens may be able to be clearly differentiated by their color, their opacity, their outer or inner texture, for example. According to one embodiment, the outer lens 1 may comprise a portion 11 which is separated from the first layer 5 equipped with its mounting prong 6. In this embodiment, the portion 11 is joined by means of the second layer 8 to the first layer 5 equipped with the mounting prong 6. In other words, the second layer extends between the portion 11 of the outer lens 1 and the first layer 5.

In the variants illustrated, the outer lens 1 is delimited peripherally by a plurality of edges. The first layer 5 and the second layer 8 are completely superimposed all along at least one of the edges that delimit the outer lens 1. According to the exemplary embodiment, the edge where the two layers 5, 8 are superimposed is the one that runs along a rear quarter panel of the vehicle capable of receiving the lighting and/or signaling device 2 equipped with the outer lens 1.

The outer lens 1 illustrated in FIG. 1 might be intended for a vehicle rear light use, advantageously a driver's-side rear light, for a left-hand drive vehicle. Of course, the invention also applies to a right rear light, according to the same frame of reference.

The outer lens may have the advantage of comprising various lighting and/or signaling functions owing to the presence of at least one portion 11 of outer lens 1 that differs from the remainder of the outer lens 1. The second layer 8 and/or the portion 11 of outer lens 1 may be translucent. The portion 11 of outer lens 1 might correspond to a direction indicator or a reversing light. The outer lens 1, with the exception of the portion 11 of outer lens 1, might correspond to a stoplight or to a side marker light also referred to as a town light or position light. The various materials used for the first layer 5 and second layer 8 may differ, for example and nonlimitingly, by their respective colors in order to have different lighting or signaling functions.

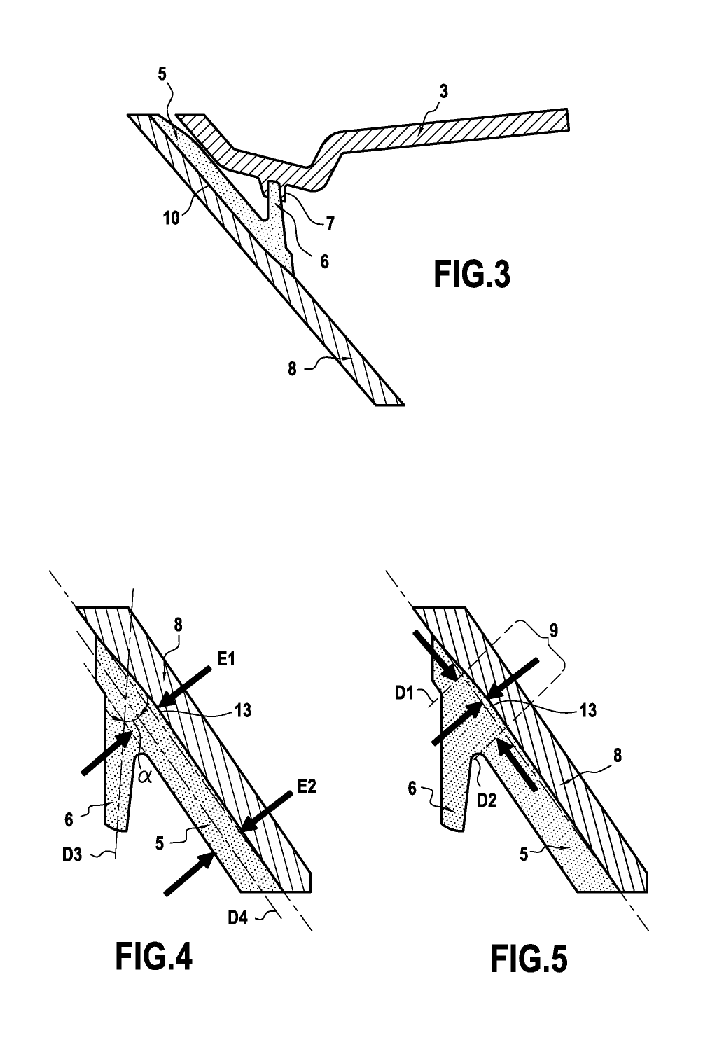

FIG. 2 illustrates the lighting and/or signaling device 2 as an exploded view, comprising a light source (not illustrated) and a housing 3 having an opening 4 through which a light beam (not illustrated) generated by the light source leaves the lighting and/or signaling device 2. The housing 3 is sealed by the outer lens 1 illustrated previously in FIG. 1. The housing 3 comprises a peripheral rib 7 which delimits the opening 4 and which also acts as a means for fastening the outer lens 1 to the housing 3 by cooperation with the mounting prong 6 (shown in FIGS. 3-5) made as one piece with the first layer 5 of the outer lens 1.

The cross-sectional view of FIG. 3 illustrates the cooperation between the outer lens 1 and the housing 3. The mounting prong 6 protruding from the first layer 5 is intended to cooperate with the peripheral rib 7 on the edge delimiting the opening 4 of the housing 3 of the lighting and/or signaling device 2. The second layer 8 covers the first layer 5 at least in the zone of cooperation between the mounting prong 6 and the peripheral rib 7. An exemplary embodiment is possible according to which the second layer 8 adheres completely to the face 10 of the first layer 5 opposite the mounting prong 6. The second layer 8 may completely cover the first layer 5.

FIGS. 4 and 5 are cross-sectional views illustrating very particularly an overthickness 13 made on the first layer 5.

In FIG. 4, the outer lens 1 comprises the first layer 5 and the mounting prong 6 protruding from the first layer 5. The second layer 8 covers the first layer 5 at least level with the mounting prong 6. The mounting prong 6 extends along the longitudinal direction D3. This longitudinal direction D3 corresponds to the direction of the longest axis of the mounting prong 6 passing through the center thereof.

The first layer 5 extends along a direction D4 represented by dotted lines which passes through the center of a thickness E2, located outside of a zone 9 corresponding to a zone of overthickness 13 of the first layer 5 level with the mounting prong 6. The longitudinal direction D3 and the direction D4 form an angle α, the measurement of this angle making it possible to assess the degree of inclination of the mounting prong 6 with respect to the plane of the outer lens 1. In one exemplary embodiment, the angle α may be between 1° and 89° or between 91° and 179°. In another exemplary embodiment, the angle α is between 10° and 80° or between 100° and 170°.

The zone 9 corresponding to the zone of overthickness 13 of the first layer 5 is delimited by two straight lines represented by D1, D2. The straight lines D1 and D2 are advantageously parallel to one another. They are transverse to the first layer 5 and each pass through a base delimiting the mounting prong 6, such a base being the portion of the first layer 5 where the mounting prong 6 begins.

With reference to FIG. 4, the first layer 5 has different thicknesses. A first thickness E1 of the first layer 5 measured in the first zone 9 between the straight lines D1 and D2, level with the mounting prong 6, will be noted which corresponds to the zone of overthickness of the first layer 5. A second thickness E2 of the first layer 5 is measured next to the mounting prong 6, outside of the zone 9, as represented in the figure. The first thickness E1 is greater than or equal to the second thickness E2 of the first layer 5. According to one exemplary embodiment, the first thickness E1 is equal to 1.15 to 1.25 times the second thickness E2.

The measurement of the variation in thickness of the first layer 5 makes it possible to assess the injection-molded overthickness level with the mounting prong 6 in order to eliminate the sink mark problem. As illustrated, the variation in thickness between the first thickness E1 and the second thickness E2 may be progressive. This makes it possible not to have a cutting edge that could weaken the first layer 5 and that could make visible marks on the outer face of the outer lens 1. A smoothing of the overthickness 13 is facilitated by the squashing of the excess material of the first layer 5 during the process of injection molding the material corresponding to the second layer 8.

The outer lens 1 is intended to seal the opening 4 of the housing 3. The process for manufacturing the outer lens 1 comprises the injection molding of a first layer 5 so as to create an overthickness 13 level with the mounting prong 6, then the injection molding of a second layer 8 covering the first layer 5 at least level with the mounting prong 6. The mounting prong 6 is intended to be lodged in the peripheral rib 7 delimiting the opening 4. The process advantageously makes it possible to flatten the overthickness 13 of the first layer 5 when the second layer 8 is injection molded. Thus manufactured, the outer lens 1 exhibits no defect or sink mark level with the mounting prong 6.

The invention is not limited to the embodiments described, but extends to any embodiment in keeping with the spirit thereof.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. An outer lense of a lighting and/or signaling device intended to seal an opening of a housing of said lighting and/or signaling device, comprising:
a first layer and a mounting prong protruding from said first layer, said mounting prong being intended to cooperate with a peripheral rib delimiting said opening; and
a second layer covering said first layer at least level with said mounting prong, in which a first thickness (E1) of said first layer measured level with said mounting prong is greater than a second thickness (E2) of said first layer measured next to said mounting prong.

2. The outer lens according to claim 1, in which a first zone of said first layer bearing said mounting prong is delimited by two straight lines, a measurement of said first thickness (E1) being carried out in said first zone between said two straight lines (D1, D2), whereas a measurement of said second thickness (E2) is carried out outside of said first zone.

3. The outer lens according to claim 1, in which said mounting prong extends along a longitudinal direction (D3) and said first layer extends along a direction (D4), said longitudinal direction (D3) and said direction (D4) forming a non-perpendicular angle (α).

4. The outer lens according to claim 2, in which said first thickness (E1) is equal to 1.15 to 1.25 times said second thickness (E2).

5. The outer lens according to claim 1, in which a variation in thickness between said first thickness (E1) and said second thickness (E2) is progressive.

6. The outer lens according to claim 1, in which said second layer completely covers said first layer.

7. The outer lens according to claim 1, in which said second layer completely adheres to one face of said first layer.

8. The outer lens according to claim 1, in which said first layer and/or said second layer is made from material selected from polymethyl methacrylate, acrylonitrile butadiene styrene and polycarbonate.

9. The outer lens according to claim 1, in which said second layer is translucent.

10. The outer lens according to claim 1, in which a portion of said outer lens, of the same material as that of said first layer and separate therefrom, is joined edge to edge with said second layer of said outer lens.

11. The outer lens according to claim 10, wherein said portion of said outer lens is translucent.

12. The outer lens according to claim 10, in which said portion is separated from said first layer equipped with said mounting prong.

13. A lighting and/or signaling device comprising a light source and a housing having an opening through which a light beam generated by said light source leaves said lighting and/or signaling device, said opening being sealed by an outer lens according to claim 1.

14. The lighting and/or signaling device according to claim 13, in which a mounting prong is welded into a peripheral rib of said housing.

15. The lighting and/or signaling device according to claim 13, in which said device is a motor vehicle rear light.

16. A process for manufacturing an outer lens intended to seal an opening of a housing of a lighting and/or signaling device, comprising:
a first layer injection molded so as to create an overthickness level with a mounting prong intended to be lodged in a peripheral rib delimiting said opening; and
an injection-molded second layer covering said first layer at least level with said mounting prong.

17. The process for manufacturing said outer lens according to claim 16, wherein said overthickness of said first layer is flattened when said second layer is injection molded.

18. The outer lens according to claim 2, in which said mounting prong extends along a longitudinal direction (D3) and said first layer extends along a direction (D4), said longitudinal direction (D3) and said direction (D4) forming a non-perpendicular angle (α).

19. The outer lens according to claim 2, in which said second layer completely covers said first layer.

20. The outer lens according to claim 2, in which said second layer completely adheres to one face of said first layer.
